(19) United States
(12) Patent Application Publication
(10) Pub. No.: US 2013/0270496 A1
(43) Pub. Date: Oct. 17, 2013

(54) Weed pulling tool

(71) Applicant: Alex McCrae, Miramar, FL (US)

(72) Inventor: Alex McCrae, Miramar, FL (US)

(21) Appl. No.: 13/815,363

(22) Filed: Feb. 25, 2013

Related U.S. Application Data
(60) Provisional application No. 61/602,127, filed on Feb. 23, 2012.

(51) Int. Cl. A01B 1/16

(52) U.S. Cl. CPC A01B 1/16
USPC 254/132

(57) ABSTRACT

A weed pulling tool having a handle and an arcuate base connected to the handle, the base having a pair of font projecting tines, a floor between the times for scooping, and a rearward projecting arcuate claw, the front times each having a pointed tip and beveled inside edges that form a sharp edge for cutting through vegetation and the rearward claw being formed by a pair of rearward tines spaced apart for penetrating and scooping weeds, the rearward tines also having beveled interior side edges that form a sharp edge.

### CROSS REFERENCE TO RELATED APPLICATIONS

This application claims the benefit of provisional patent application Ser. No. 61/602,127 Feb. 23, 2012.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

This invention relates generally to a weeding tool, and more particularly, to a weed pulling tool having multiple prongs for addressing and pulling weeds and a leveraged system for making weed pulling easier with minimal stress on the back and legs.

2. Description of the Background Art

A variety of weeding tools are known in the background art. The weeding tools known include rakes, claws, hoes, hand tools, spades and others. Conventional weeding tools are either rudimentary such that they fail to provide any physical advantage over difficult weeds and weeds in general and, or put stress on the back and legs or they are overly complicated, difficult to use, expensive and continue to put stress on the back and legs.

The weeding tools known in the art do not address or resolve the problems in the background art. For instance, U.S. Pat. No 203,798 issued to Turmer on May 14, 1878 discloses a weeding implement. U.S. Pat. No. 637,091, issued to Cutter on Nov. 14, 1899 discloses another weeding implement. U.S. Pat. No. 1,079,619 issued to Walton on Nov. 25, 1913 discloses a weed puller. U.S. Pat. No. 1,170,122 issued Feb. 1, 1916 to Stuart discloses a weeding tool. U.S. Pat. No. 1,337,939 issued Apr. 20, 1920 to Miller discloses a combined fork, rake and knife U.S. Pat. No. 2,335,182 issued to Hill on Nov. 23, 1943 discloses a weed destroying tool. U.S. Pat. No. 2,532,115 issued to McKinney on Nov. 28, 1950 discloses a weed extractor U.S. Pat. No. 3,288,437 issued Nov. 29, 1966 to Pederson discloses a garden weeding tool. U.S. Pat. No. 4,180,289 issued to Faine on Dec. 25, 1979 discloses a gardening tool. U.S. Pat. No. 6,056,068 issued to O'Callaghan May 2, 2000 discloses a weed removal tool. U.S. Pat. No. 6,401,833 issued to Hixon Jun. 11, 2002 discloses a dry plant harvester. U.S. Pat. No. 7,658,422 issued Feb. 9, 2010 to Carr discloses a gardening tool. U.S. Design Pat. No. D251,408 issued Mar. 27, 2009 to Cumberlidge et al. discloses a weed fork. U.S. Patent Publication No. 20010045293 to Tam discloses a weed removal tool. U.S. Patent Publication No. 20040065452 to Baker discloses a weed digger apparatus. U.S. Patent Publication No. 20100200255 to Gee discloses a gardening tool. The foregoing prior art, however, does not disclose a weed pulling tool that is convenient to use, provides a physical advantage over difficult weeds or that eliminates stress on the back as contemplated by the instant invention.

Despite certain advancements with weeding tools, they fail to adequately address or resolve these concerns in the prior art and thus have not been widely accepted. Conventional weeding tools are simply either too difficult to use, cause pain or are ineffective. If there existed a weeding tool that was easier to use, did not cause pain and was effective, it would be well received. However, there are no such weeding tools known that address these issues. Therefore, there exists a need for a weeding device that addresses these needs in the prior art. It is, therefore, to the effective resolution of the aforementioned problems and shortcomings of the prior art that the present invention is directed. The instant invention addresses this unfulfilled need in the prior art by providing such a weeding tool, as contemplated by the instant invention disclosed herein.

### BRIEF SUMMARY OF THE INVENTION

In light of the foregoing, it is an object of the present invention to provide a weed pulling tool that is convenient to use.

It is also an object of the instant invention to provide a weed pulling tool that provides a physical advantage over difficult to reach weeds.

It is another object of the instant invention to provide a weed pulling tool that is not difficult on the back or legs.

It is an additional object of the instant invention to provide a weed pulling tool that is simple in construction.

It is a further object of the instant invention to provide a weed pulling tool that is cost effective to make.

In light of these and other objects, the instant invention comprises a weed pulling tool having a handle and an arcuate base affixed to the handle. The base has a pair of front tines, a floor defined between the front tines and a pair of rear tines. The front tines project forward from the handle and each comprise a pointed tip. The front tines have beveled edges that define pointed edges to facilitate cutting through thick vegetation. The floor allows dirt to be scooped up and vegetation penetrated for disabling and removing weed. The rear tines comprise arcuate claws that project rearward from the handle.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 is a perspective view of the weeding pulling tool in accordance with the preferred embodiment of the instant invention.

FIG. 2 is a side elevational view of the weed pulling tool in accordance with the preferred embodiment of the instant invention.

FIG. 3 is a bottom elevational view of the weed pulling tool in accordance with the preferred embodiment of the instant invention.

### DETAILED DESCRIPTION OF THE INVENTION

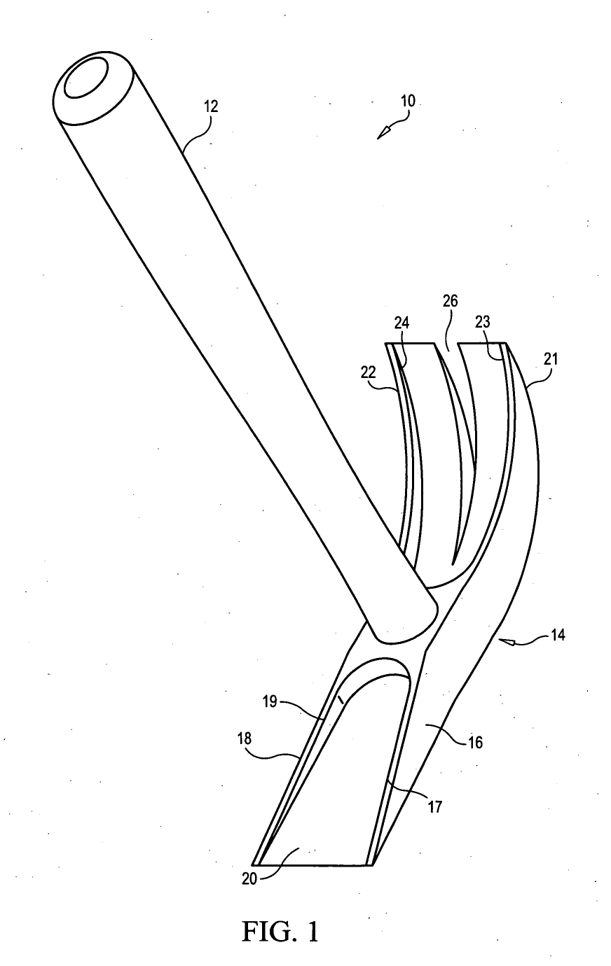

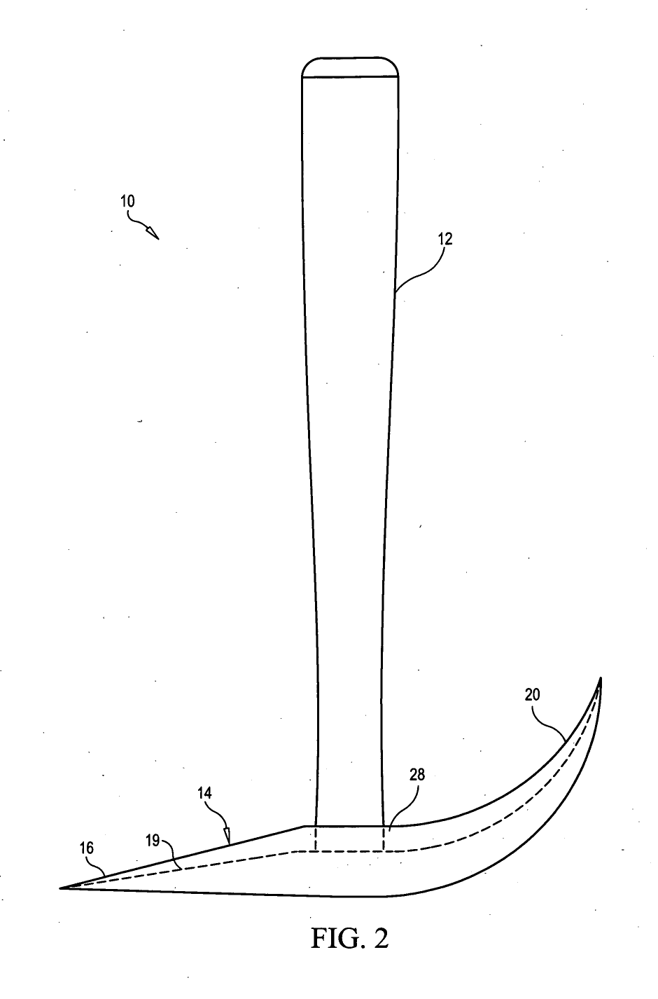

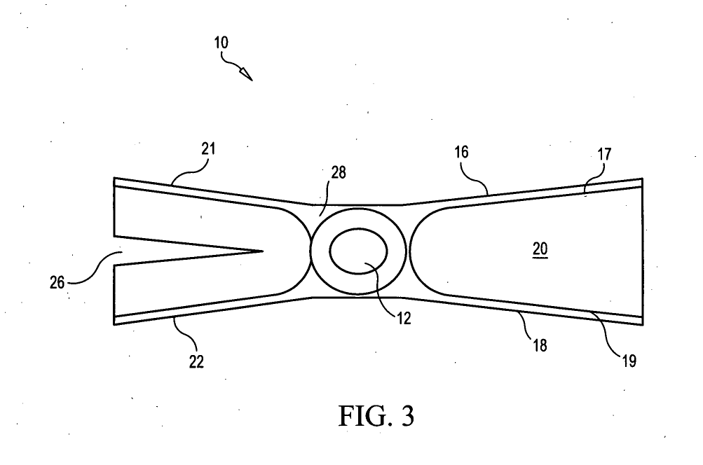

With reference to the drawings, FIGS. 1 to 3 depict the preferred embodiment of the instant invention which is generally referenced as a weed pulling tool and, or by numeric character 10. The weed pulling tool 10 is designed to make it easy to pull weeds without bending over or putting harmful stress on one's back. The weed pulling tool 10 comprises two sets of tines that give the user leverage to more conveniently, efficiently and effectively engage and pull weeds, especially the type of weeds that are more embedded in the soil.

With reference to FIGS. 1-3, the weed pulling tool 10 comprises an elongated handle 12 and an arcuate base 14 affixed to the handle 12. The base 14 has a pair of front tines 16, 18, a floor 20 defined between the front tines 16, 18 and a pair of rear tines 21, 22. The front tines 16, 18 project forward from the handle 12 and each comprise a pointed tip and become progressively thicker as the tines 16, 18 approach the handle 12. The tines 16, 18 may also have inward beveled edges 17, 19 that define pointed edges along the top and, or sides to facilitate cutting through thick vegetation. The front times 16, 18, beveled edges 17, 19 and floor 20 allow dirt to be scooped up and vegetation penetrated for disabling and removing weed. The rear tines 21, 22 comprise arcuate claws that project rearward from the handle 12 and front tines 16, 18. The rear tines 21, 22 define a gap 26 between them to facilitate penetrating and scooping up weeds. The rearward tines 21, 22 may also comprise inward beveled edges 23 and 24 to further enable the ability to cut though weeds, grass and brush.

Still referring to FIGS. 1-3, the handle 12 projects upward from the base 14. The handle 12 at its base is preferably secured in a base opening 28 between the front tines 16, 18 and rear tines 21, 22. The handle 12 may be secured in the base opening 28 by an adhesive, fasteners or other known devices and methods.

The instant invention has been shown and described herein in what is considered to be the most practical and preferred embodiment. It is recognized, however, that departures may be made therefrom within the scope of the invention and that obvious structural and/or functional modifications will occur to a person skilled in the art.

What is claimed is:

1. A weed pulling device, said device comprising:
an elongated handle;
an arcuate base connected to said handle;
said arcuate base comprising a pair of front tines projecting forward from said handle, a floor between said front times for scooping and a claw projecting rearward from said handle; and
said front tines having pointed tips and beveled edges to facilitate cutting through weeds and thick vegetation.

2. A device as recited in claim 1, wherein said claw is arcuate and comprises a pair of spaced rear tines.

3. A device as recited in claim 2, wherein said rear tines each comprise beveled interior side edges, said beveled interior side edges comprising a sharp edge.

4. A device as recited in claim 2, wherein said claws comprise flat tips.
